(19) United States
(12) Patent Application Publication
(10) Pub. No.: US 2010/0039645 A1
(43) Pub. Date: Feb. 18, 2010

(54) METHOD AND SYSTEM FOR PARTICLE DETECTION

(75) Inventor: Kemal Ajay, Victoria (AU)

Correspondence Address: SCHWEGMAN, LUNDBERG & WOESSNER, P.A., P.O. BOX 2938, MINNEAPOLIS, MN, 55402, US

(73) Assignee: Xtralis Technologies Ltd, Nassau,NP (BS)

(21) Appl. No.: 12/530,509

(22) PCT Filed: Mar. 7, 2008
(86) PCT No.: PCT/AU08/00315

§ 371 Date: Sep. 9, 2009

(30) Foreign Application Priority Data
Mar. 9, 2007 (AU) 2007901285

(51) Int. Cl. G01N 21/00

(52) U.S. Cl. 356/341

(57) ABSTRACT

An apparatus for detecting particles in an airflow is disclosed. The apparatus can include at least one light source for illuminating a one or more portions of the airflow, at least one photo-detector positioned to detect light scattered from one or more illuminated volumes of the airflow. The at least one light source and at least one photo detector are arranged such that a signal indicative of light scattered from a plurality of illuminated volumes can be derived from the output of the at least one photo detector. The apparatus also includes a signal processing apparatus configured to process said signals indicative of light scattered from a plurality of illuminated volumes to determine whether particles have been detected in the airflow.

### FIELD OF THE INVENTION

The present invention relates to a method and system for detecting particles. The preferred embodiments of the present invention will be described in the context of detecting smoke. However, the present invention should not be considered as being limited to this exemplary application.

### BACKGROUND OF THE INVENTION

Particle detectors which detect airborne particles on the basis of the amount of light scattered from a beam of radiation, such as the smoke detectors sold under the trade mark VESDA by Xtralis Pty Ltd, provide a highly sensitive way of detecting particles. These smoke detectors operate by transmitting a beam of light, typically from a laser, or flash tube, through a stream of air in which particles may be present. A photo-detector, such as a photodiode or other light sensitive element is placed at a predetermined position with respect to illuminated volume and the amount of scattered light received by the photo-detector is used to determine the level of particulate matter in the airflow.

Due to the relatively small “region of interest” of such detectors, and the relatively low scattering efficiency of the airstream which may be as low as 0.005% obscuration per metre, the photo-detector must be highly sensitive. The region of interest can be defined as the region of intersection between the volume illuminated by the light source, and volume from which the light receiver may receive light. Typically in such detectors, the difference between the level of received light, with and without smoke (at a level sufficiently high to be of interest), is in the picowatt range. Therefore the detection electronics and software which analyses the output from the detector must be finely tuned to correctly distinguish particles in the airstream, from background signals and noise.

Because of the high level of sensitivity required, such smoke detectors are at risk of producing false alarms if a foreign body such as a dust particle or insect enters the “region of interest” of the detector.

In order to minimise the possibility of unwanted material entering the region of interest, or the detection chamber of the particle detector at all, a variety of screening and filtering solutions have been proposed. One such example is the use of a “bulk filter” such as a foam or paper filter, which is used to filter out particles larger than the particles to be detected. However, the particles of interest (such as smoke particles) may occur in a variety of sizes depending on application and filters need to be chosen carefully to avoid removing particles of interest. Moreover, even if such filters are selected correctly initially, as such conventional bulk filters clog they begin to remove more particles from the air and will eventually begin filtering out the small particles of interest. This may be due to the effective pore sizes of the filter being reduced as more particles clog the filter. This can be a problem because such filters start undesirably removing the particles of interest before the flow rate through the filter changes appreciably. The result is that the filter may begin removing an unknown proportion of the particles of interest.

An alternative solution to using a bulk filter is using a screen filter, such as a mesh filter, which will capture all particles having a cross section larger than the mesh hole size. However, such mesh filters do not prevent some elongate particles from passing through them.

In some instances, it is also possible for an accumulation of dust to build up in the detection chamber or for particles to adhere to each other to an extent that long filaments of dust, “grow” in the detection chamber. In extreme situations this may continue until the long filaments impinge upon the region of interest.

Clearly with such highly sensitive devices any large object that impinges on the illuminated volume will cause a significant level of light scattering in the detection chamber which may lead (or contribute) to an the triggering of a false alarm. This is particularly the case if the object enters the region of interest.

Accordingly, it is desirable for particle detectors, such as smoke detectors to have systems and methods to identify or prevent false alarms caused by the impingement of unwanted contaminants in their detection regions.

### SUMMARY OF THE INVENTION

In a first aspect the present invention provides a method of detecting particles in an airflow, the method including: illuminating a first volume through which at least part of the airflow passes detecting light scattered from the first volume; illuminating a second volume through which at least part of the airflow passes; comparing a value indicative of the light scattered from the first volume to a value indicative of the light scattered form the second volume; and determining whether particles have been deleted in the airflow at last partially on the basis of the comparison.

Preferably the step of determining whether particles have been detected in the airflow includes comparing a level of light scattered from the first and second volumes. In the event that the value indicative of the light scattered from the first and second volumes are substantially equal, the light scattering can be determining to be the result of particles of interest present in the airflow. Alternatively in the event that the level of light scattered from the first and second volumes are different, it can be determined that a fault condition exists in the detector. The method may also include providing notification that a fault condition exist.

Preferably the particles to be detected are smoke particles.

In a second aspect the present invention provides a method of identifying a false particle detection condition in a particle detector configured to detect particles in an airflow the particle detector including, means for illuminating a plurality of volumes traversed by at least part of the airflow, means for detecting light scattered from the plurality of volumes, said method including; comparing measurements indicative light scattered from the first volume and the second volume; and in the event that the light scattered from the first volume and the second volume do not correspond to substantially the same level of particles in the air flow; identifying that a false particle detection condition has occurred.

In the event that light scattered from the first volume and the second volume are substantially the same the method includes identifying that a false particle detection condition has not occurred.

In a third aspect the present invention provides an apparatus for detecting particles in an airflow the apparatus including: at least one light source for illuminating a plurality of volumes within the airflow; a plurality of photo-detectors positioned to detect light scattered from a respective one of the illuminated volumes; a signal processing apparatus configured to process an output of at least two of said photo-detectors and to determine whether particles have been detected in the airflow.

In another aspect there is provided an apparatus for detecting particles in an airflow the apparatus comprising: at least one light source for illuminating at least one volume through which at least part of the airflow passes; at least one photo-detector positioned to detect light scattered from a respective illuminated volume, so as to define a plurality of regions of interest at the intersection of a field of view of the photo detector and the illuminated volume; a signal processing apparatus configured to process an output of at least two of said photo-detectors and to determine whether particles have been detected in the airflow.

The apparatus can include a plurality of light sources for illuminating a plurality of volumes within the airflow.

The signal processing apparatus can include means to compare a value representative of the outputs of two or more photo-detectors. The output of the comparison can be used to determine whether a particle detection fault has occurred. In the event that the value representative of the outputs of two or more photo-detectors are similar no fault is detected. In the event that comparison indicates that different levels of scattered light have been received at the plurality of photo-detectors a fault condition is identified. Typically this fault condition will indicate that there is a foreign body (i.e. not a particle intended to be detected) within one or the illuminated volumes within the airflow.

The first volume and the second volume can be illuminated by separate light sources. Alternatively they can be illuminated by a common light source.

If the first and second volumes are illuminated by separate light sources, light scattered from both the first and second volumes can be monitored by either a common light detecting means or separate light detecting means.

In a fourth aspect the present invention provides an apparatus for detecting particles in an airflow the apparatus including: at least one light source for illuminating a plurality of volumes within the airflow; a plurality of photo-detectors positioned to detect light scattered from a respective one of the illuminated volumes; a processor means configured to determine a level of particles detected in the airflow and in the event that a predetermined condition is met to cause an alarm to be triggered, the processor means additionally being configured to compare a value indicative of an output of at least two of the plurality of photo-detectors and to determined an output of one of the photo-detectors is affected by a contaminant in its respective illuminated volume.

In the event that the values indicative of an output of at least two of the plurality of photo-detectors are not substantially equal it can be determined that a contaminant is present in one of the illuminated volumes of the apparatus. The processor means can be configured to not trigger an alarm if it determines that a contaminant is present in one of the illuminated volumes of the apparatus.

In a fifth aspect the present invention provides an apparatus for detecting particles comprising; a plurality of light sources illuminating a plurality of volumes within an airflow, at least one photo-detector able to detect light scattered by particles within at least two of said volumes; and wherein said light sources may be individually controlled in intensity in time to permit determination of which of said at volumes is the source of scattered light received at a photo-detector.

The light sources may be individually controlled in intensity according to a predetermined scheme. The intensity modulation of the light sources can be correlated with detected light scatter to determine which volumes is the source of scattered light received at a photo-detector.

Each light source can be modulated in intensity with a unique sequential code. The code may be selected from a set of orthogonal or near-orthogonal codes, for example a Gold code.

The particle detection apparatus can additionally include signal processing configured to recover a signals indicative of detected light scattered from each volume using correlation techniques.

In the event that the values derived from at least two of the aforementioned plurality of volumes are not substantially equal, it can be determined that a contaminant is present in at least one of the volumes of the apparatus.

In a further aspect the present invention provides an apparatus for detecting particles of the type that detects light scattering from an illuminated volume to determine a level of particles in an airflow passing through said illuminated volume; said particle detection apparatus including a plurality of spatially separated, monitored, illuminated volumes from which scattered light is to be detected by one or more light detection stages; wherein said particle detection apparatus is configured to compare a signal indicative of the light scattered from a plurality of monitored, illuminated volumes to confirm the detection of particles in the airflow.

The particle detection apparatus can be configured to confirm the detection of particles in the airflow if the output of a plurality of light detection stages that monitor a common airflow is substantially the same.

In this case the particle detection apparatus preferably includes a plurality of light sources configured to illuminate respective volumes of a common airflow. Preferably the light sources are activated and deactivated to illuminate their respective volumes of the airflow in a predetermined pattern or in a manner responsive to a level of particles detected.

Advantageously in the event that a predetermined concentration of particles are detected, or the rate or change of the concentration of particles detected (or some other metric) meets a predetermined condition, one or more of the light sources can be temporarily turned off. This allows an output from light detection stages monitoring the remaining illuminated light sources to be separately processed.

Advantageously this allows fault conditions that affect the level of scattered light being received, such as the entry of foreign body into the illuminated volume, to be detected.

In another aspect the present invention provides a method in a particle detector of the type in which an air flow to be analysed passes through a detection chamber, for validating an initial particle detection event in respect of a first volume through which the airflow passes, the method including: attempting to detect particles in a second volume in the airflow that is different to the first volume in which the initial particle detection event occurred; and if a particle detection event occurs in the second volume; validating the initial particle detection event.

The method may include attempting to detect particles in a first volume, and if particles are detected, determining that an initial particle detection event has occurred.

The first volume may include the second volume. Alternatively the second volume may include the first volume.

The method can include causing alarm if the initial particle detection event is validated and one or more additional alarm conditions is met.

In another aspect the present invention provides an apparatus for detecting particles in an airflow the apparatus including: at least one light source for illuminating a one or more portions of the airflow; at least one photo-detector positioned to detect light scattered from one or more illuminated volumes of the airflow; wherein said at least one light source and at least one photo detector are arranged such that a signal indicative of light scattered from a plurality of illuminated volumes can be derived from the output of the at least one photo detector; and a signal processing apparatus configured to process said signals indicative of light scattered from a plurality of illuminated volumes to determine whether particles have been detected in the airflow.

### BRIEF DESCRIPTION OF THE DRAWINGS

Preferred forms of the present invention will now be described, by way of non limiting example only, with reference to the accompanying drawings, in which:

FIG. 1 is a cross sectional view through a smoke detector made in accordance with the first embodiment of the present invention;

FIG. 2 is a cross sectional view of the detection chamber of the smoke detector of FIG. 1;

FIG. 3 is a schematic view of the detection chamber of the smoke detector of FIG. 1;

FIG. 4 is a cross section through a smoke detector according to a second embodiment of the present invention;

FIG. 4A is a cross sectional view of the smoke detector perpendicular to that shown in FIG. 4;

FIG. 5 is a cross section through a third embodiment of a smoke detector with multiple smoke detection channels operating in accordance with an embodiment of the present invention;

FIG. 6 is a cross section through another embodiment of a smoke detector with multiple smoke detection channels operating inn accordance with an embodiment of the present invention;

FIG. 7 is a cross section through yet another embodiment of the present invention;

FIG. 8 illustrates a variant of the embodiment of FIG. 7; and

FIG. 9 illustrates another embodiment of the present invention.

### DETAILED DESCRIPTION OF THE EMBODIMENTS

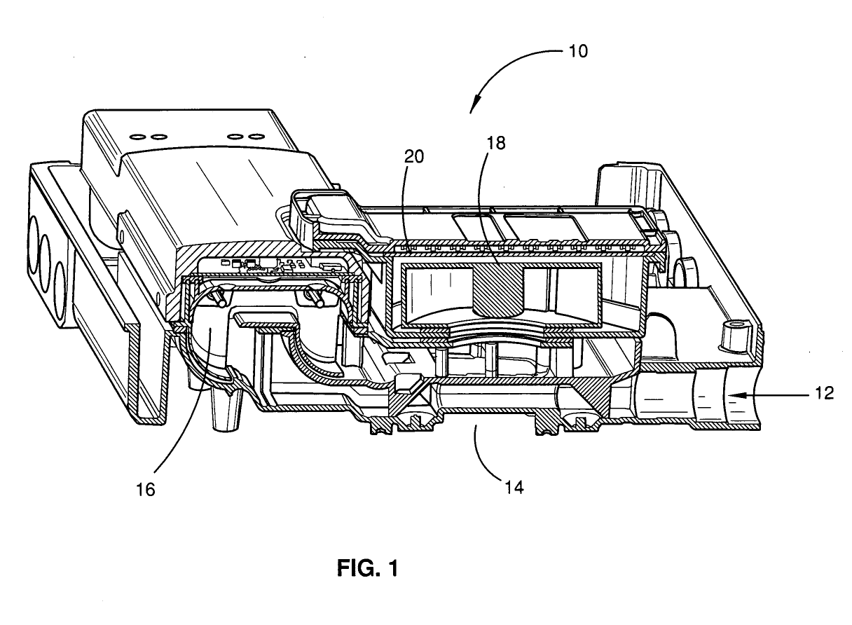

FIG. 1 shows a cross section taken through a smoke detector 10, which operates in accordance with an embodiment of the present invention. Smoke detector 10 is fully described in our co-pending patent application, filed on the same date as the present application entitled “Particle Detection Apparatus”, and filed in the name of Xtralis Technologies Limited.

In general terms, the smoke detector 10 includes an airflow path beginning with an input port 12 into which an air sample is drawn, typically from a sampling pipe network. The airflow passes into a flow detection region 14 in which the speed of flow is determined. The flow rate may determined by any means, but preferably is conducted using an ultrasonic flow sensor such as the one described in International patent publication no. WO2004/102499, the contents of which are incorporated herein by reference. After passing out of the flow detection region 14 the airflow passes into the detection chamber 16 of the smoke detector 10 in which the airflow is analysed to determine whether it contains smoke, and if so, whether an alarm condition should be triggered. The airflow is extracted from the detection chamber 16 by a fan 18 and vented via an exhaust port (not shown) out of the detector 10. As discussed in our co-pending application, a proportion of the exhaust air is also filtered by filter element 20 and the clean air supplied to a housing containing the detection electronics to clean its optical surfaces.

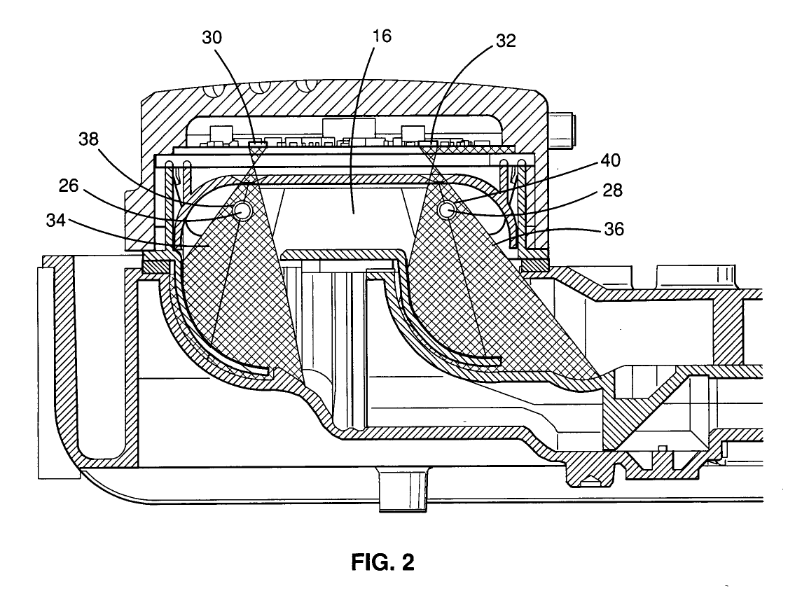

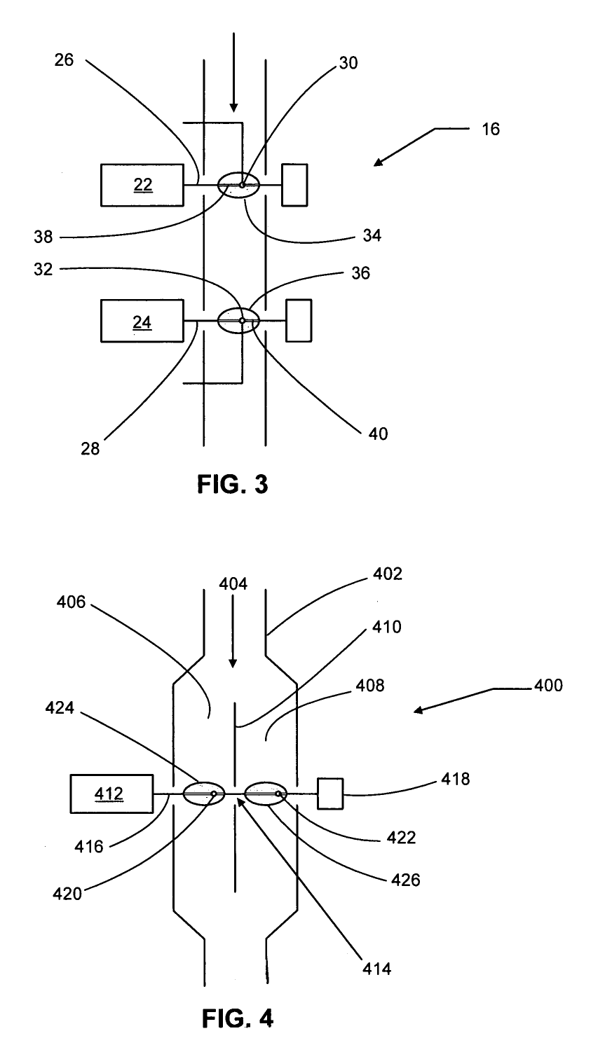

Additional detail of detection chamber 16 of the present embodiment is shown in FIGS. 2 and 3. In this regard, FIG. 2 depicts a cross sectional view of the detection chamber 16 of the detector 10, whilst FIG. 3 shows a schematic cross-sectional view of the detection chamber from above.

In the preferred embodiment, the detection chamber 16 includes two light sources e.g. lasers 22 and 24 configured to emit respective beams of electromagnetic radiation 26 and 28 which traverse the airflow in the detection chamber 16. A pair of photo-detectors 30 and 32 are provided which are able to sense light over respective sensing volume 34 and 36 respectively. Each photo-detector 30 and 32 is aligned with a corresponding laser beam 26 and 28 so that its field of view intersects with a portion of laser beam forming two regions of interest 38 and 40. As will be appreciated, the volume 34 and 36, being monitored by each photo-detector 30 and 32, is generally conical, as can be seen by the cross section illustrated in FIG. 2. The region of interest being monitored for laser beam 26 is illustrated with reference numeral 38 and the region of interest being monitored for laser beam 28 is given reference numeral 40 in FIG. 3.

In use, when particles suspended in the airflow pass through the regions of interest 38 and 40 light from each of the laser beams will be scattered out of the laser's direct path. A portion of this scattered light from each beam 26 and 28 will be scattered in the direction of the respective photo-detectors 30 and 32 and be received thereby. From the signal output from the photo-detectors the level of particulate matter in the airflow can be inferred. Those skilled in the art will appreciate that various techniques are known to differentiate different particle types, e.g. differentiating smoke from dust, by selecting an appropriate geometry for the laser beams and photo detectors.

Because the regions of interest are spatially distinct, when particles suspended in the airflow in the detection chamber 16 pass one of the regions of interest 38 and 40 light will only be detected by its respective photo detector 32, 34 but not the other. By comparing the output from each of the detectors a determination can be made whether similar particulate loads are being detected by each detector. The inventor has determined that, in the event that substantially similar particulate loads are detected in both regions of interest it is reasonable to infer that, absent any independently detected signs of device failure, that the detectors are operating correctly and that the scattering being detected by the photo-detectors is the result of particles entrained in the airflow as these will typically be spread uniformly throughout the detection chamber. On the other hand, if the particulate loads inferred from the scattering being detected by the photo-detectors are different it is likely that the output of at least one of the detectors does not reflect the level of particles of interest in the airflow.

This failure to accurately detect the level of said particles in the airflow in one of the regions of interest, may be due to one of more of several factors, including, but not limited to:

a failure in one or more components associated with monitoring or illuminating one of the regions of interest that may cause either a high or low output signal,

a foreign body impinging on one of the regions of interest, that increases the level of scattering in that region of interest, or

a foreign body obscuring the view of one of the photo-detectors.

In the preferred embodiments, a comparison of the signals indicative of light scattered from multiple spatially distinct air volumes is advantageously used for detecting the presence of foreign bodies in the detection chamber.

Whilst particle detectors often have other methods of monitoring the operational condition of the detection and illumination systems, and may be provided with systems for ensuring optically critical surfaces are free from obstruction, e.g. by blowing clean air onto critical optical surfaces and through the viewing apertures for the photo-detectors, other embodiments can use the comparison of the signals derived from multiple spatially distinct air volumes to monitor these aspects of the detector operation.

FIG. 4 illustrates a second embodiment of an aspect of the present invention. In this embodiment, rather than using two light sources to illuminate two spatially distinct regions of interest of the same sample flow, a single light source is used to illuminate two regions of interest. In FIG. 4 the particle detector 400 includes a single input port 402 into which a sample flow is drawn in a direction of arrow 404. The sample is effectively split into two sub-flows 406 and 408 by wall 410. A light source 412, in this case a laser, is configured to illuminate a portion of both sub-flows 406 and 408. The wall 410 has an aperture 414 formed in it, through which the laser's beam 416 passes to enable the sub-flow located furthest from the laser 412 to be illuminated. The detector also includes a light dump 418 that is configured to terminate the laser's beam 416 in a controlled manner, i.e. with minimal back reflection into the detection chamber. A photo detector 420, 422 is placed on each side of the dividing wall 410 such that each photo-detector 420, 422 can collect light scattered from the laser's beam 416 as it passes through a corresponding sub-flow 406, 408. The intersection of the laser's beam 416 and the viewable volume 424 and 426 of each of the photo detectors 420, 422 create two spatially distinct regions of interest within the particle detector 400. Signals from each of the photo-detectors 420 and 422 can be used in the manner described in the previous embodiment to improve the robustness of smoke detections made with the smoke detector 400.

Advantageously, by providing a dividing wall between the two photo-detectors 420 and 422 the light detected by each photo detector will be largely independent of the light detected by the other. Thus if a foreign body were to enter one of the regions of interest such that it would cause unwanted light scattering, the level of scattered light received by the photo-detector monitoring the other region of interest would be largely unaffected. It may be possible to have embodiments that do not include a wall such as the one depicted in this embodiment, but simply have two photo-detectors each collecting light scattered from two different portions of the laser beam as it traverses a sample flow, but such an arrangement may be more susceptible to false alarms caused by very large particles that may enter both regions of interest, or particles which scatter light to the extent that both photo-detectors are affected even if the particle does not enter its region of interest.

This scheme of providing a plurality of regions of interest in each sample flow in order to improve the reliability of particle detection events can be extended to alternative arrangements, a selection of which will be described below.

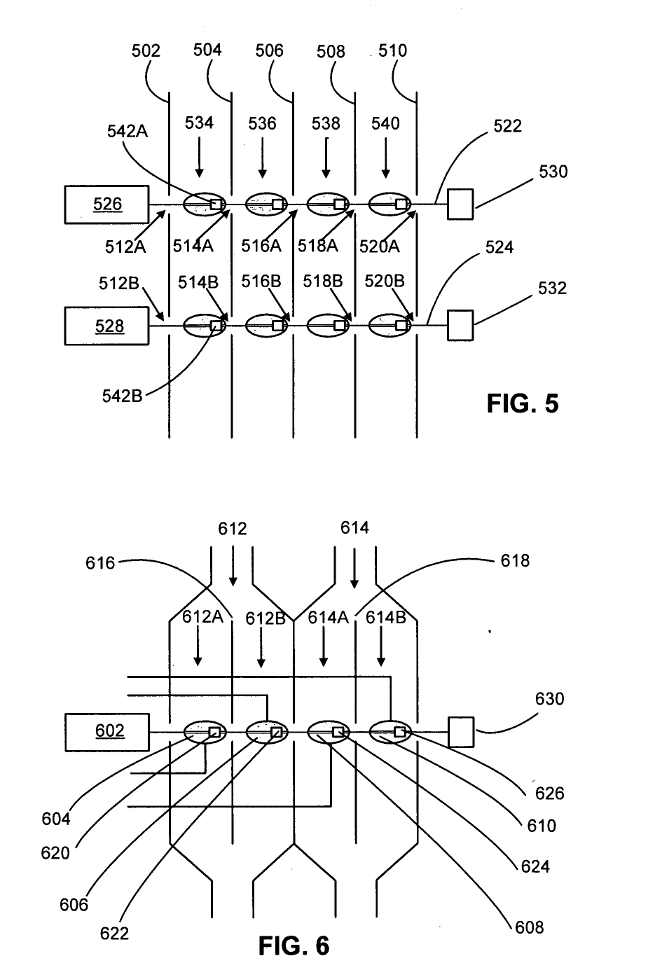

In the third embodiment, depicted in FIG. 5, a particle detector 500 is shown, in which four air samples can be analysed simultaneously using two light sources. In this embodiment a four detection chambers are defined by walls 502, 504, 506, 508 and 510. Each wall is provided with a respective pair of apertures 512A and 512B, 514A and 5124, 516A and 516B, 518A and 518B, 520A and 520B through which a corresponding beam 522 or 524 of respective lasers 526 and 528 pass. Each beam 522 and 524 is terminated in a respective light dump 530 and 532. The walls 502, 504, 506, 508 and 510 define four airflow paths 534, 536, 538 and 540 through which four airflows may pass in use. Each flow path 534, 536, 538 and 540 is provided with two photo-detectors e.g. 542A and 542B for flow path 534, which are configured to view at least part of each laser beam 522 and 524 as it traverses each flow path 534, 536, 538 and 540. As with the first embodiment each flow path is provided with two spatially distinct regions of interest e.g. regions of interest 544A and 544B for flow path 534. Thus, as will be seen each of the plurality of sample flows can be treated in the manner described in connection with the embodiment depicted in FIG. 1, with the attendant advantages.

FIG. 6 shows another embodiment of a particle detection apparatus made in accordance with an aspect of the present invention. The detector 600 of this embodiment, includes a single light source 602 to illuminate four regions of interest 604, 606, 608 and 610 in two airflows 612 and 614. The structure of the airflow paths is similar to that of FIG. 4, in which each airflow 612 and 614 is divided into sub-flows 612A, 612B and 614A, 614B respectively by a dividing wall 616 and 618, and a common laser source illuminates a portion of each of the sub-flows 612A, 612B, 614A and 614B. Similarly each sub-flow has a dedicated photo detector viewing a portion of it 620, 622, 624 and 626 to create a pair 604 and 606 and 608, 610 of spatially distinct regions of interest in each of the airflows 612 and 614. The beam 628 of the single laser 602 traverses each of the walls defining the flow paths through apertures formed in them and is terminated in a light dump 630.

The use of a plurality of spatially separated regions of interest to analyse a sample flow in a particle detection apparatus in the preferred embodiments depicted herein may require a corresponding plurality of photo detection stages.

In order to enable a detector to differentiate between a signal derived from one region of interest or another, it can be advantageous for the light source to be cycled and the distinct regions of interest to be illuminated intermittently. In systems with two or more light sources the illumination cycles of each of the regions of interest can be staggered to selectively illuminate them in a predetermined manner, e.g. for system with two regions of interest, in a first time period a only a first region of interest may be illuminated, for a second time period both regions of interest can be illuminated and for a third time period only the other (second) region of interest can be illuminated.

Another example of a suitable intensity-time control scheme is to individually switch said light sources on and off and to correlate the detected light scatter with the volume illuminated at that time. A further example of a suitable intensity-time control scheme is to use coding sequences wherein each light source is modulated in intensity with a unique sequential code. The code may be selected from a set of orthogonal or near-orthogonal codes, for example a Gold code. A signal processing means can be used to process the received scattering signals, using correlation techniques to determine the individual contribution of scatter from each volume. In the event that the values derived from at least two of the aforementioned plurality of volumes are not substantially equal, it can be determined that a contaminant is present in at least one of the volumes of the apparatus and consequently a processing means can be configured to not trigger an alarm.

In a preferred form the particle detector is of the aspirated type, and may include a fan or other means to draw air through the regions of interest. Alternatively the aspiration means may be provided as a separate component of a particle detection system. The air sample to be analysed can be continuously drawn from a room or other region being monitored for particles e.g. smoke. In this case the particle detector can be part of a system that draws an air sample through a pipe network consisting of one or more sampling pipes with sampling holes installed at positions where air carrying smoke or particles can be collected. Air is drawn in through the sampling holes and along the pipe by means of a fan and is directed through a detector at a remote location.

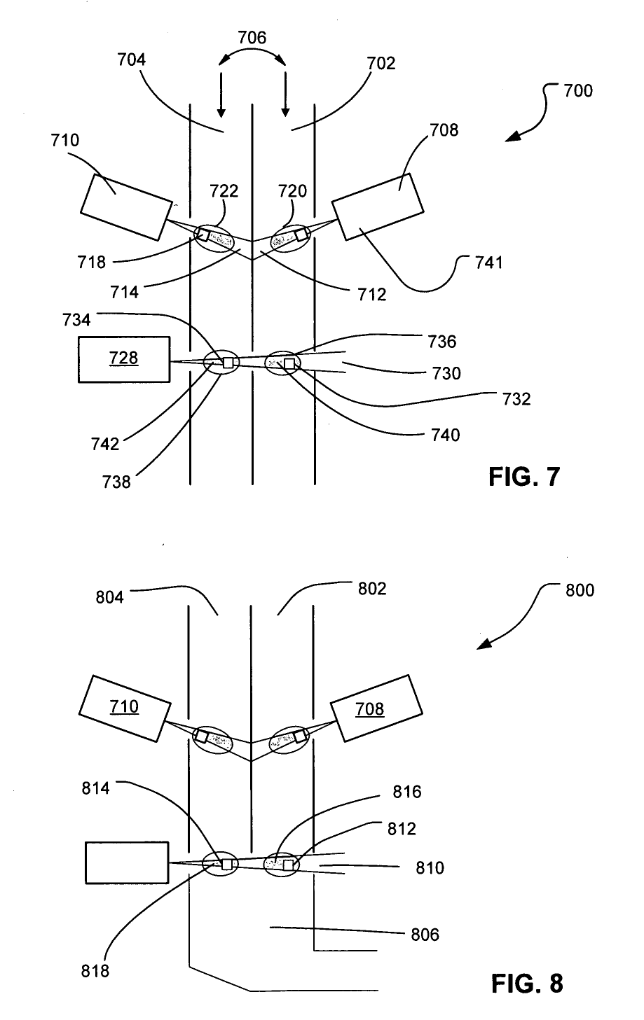

FIG. 7 illustrates a further embodiment of the present invention. In this embodiment a cross-sectional view of a particle detector 700 is shown. The particle detector 700 includes a first detection chamber 702 and a second first detection chamber 704. Airflow carrying particles to be detected travels through the detection chambers in the direction of arrows 706. The respective detection chambers 702 and 704 are each fitted with a light source 708 and 710 In this example the light sources are LED's and emit a respective beam of light 712 and 714 which traverses a respective detection chamber 702 and 704. The detection chambers 702 and 704 are fitted with a corresponding light photo detector 716 and 718. The photo detector 716 is adapted to view a volume indicated by reference numeral 720, whilst photo detector 718 is adapted to view a volume indicated by reference numeral 722. The intersection of light beam 712 and sensing region 720 forms a region of interest 724 for the first detection chamber 702, while the intersection of the light beam 714 and viewing region 722 forms a second region of interest over which particles in the airflow of detection chamber 704 may be detected.

The system 700 is additionally fitted with a third light source 728 adapted to emit a beam of light 730. Light source 728, may also be an LED or other source of non collimated radiation. Each of the detection chambers 702 and 704 are fitted with a respective second photo detector 732 and 734 which are adapted to view respective potions of the beam 730 to thereby define regions of interest 740 and 742. In use, this embodiment operates in a similar fashion to the previous embodiments with the first light sources 708 and 710 and their corresponding photo-detectors 716 and 718 being used for detecting particles in the airflows. Confirmation of particle detection or fault detection is provided by using the light source 728 to illuminate the second region of interest 740 and 742 in each detection chamber 702 and 704.

FIG. 8 illustrates a further additional implementation of the present invention. In this embodiment, the detection chambers 802 and 804 are merged at a downstream portion 806 into a single exhaust manifold. Primary particle detection operates in a manner identical to that described in connection with FIG. 7. At a point further downstream the system 800 is provided with a further light source 808 which is configured to emit a light beam 810 across the volume 806. A photo-detector 812, 814 is mounted adjacent to the exhaust end of each of the detection chambers 802 and 804. For each of the detection chambers 802 and 804 this arrangement defines a second region of interest 816 and 818 which can be used in a manner described above for validating the particle detection event or the presence of a fault condition, such as a foreign body in a region of interest of the particle detector. The second regions of interest are arranged close enough to the end of the detection chambers 802 and 804 so that the airflows have not substantially mixed and a particle detection detected by one of the second photo sensors can be attributed to one or the other of the detection chambers.

In the case where a less robust fault detection can be tolerated it is possible to take a common, second particle detection measurement further downstream in the mixed airflows in the exhaust manifold. This value may need to be corrected for effect of dilution on the received smoke signal before deciding wether a particle detection event has occurred or a fault condition exists.

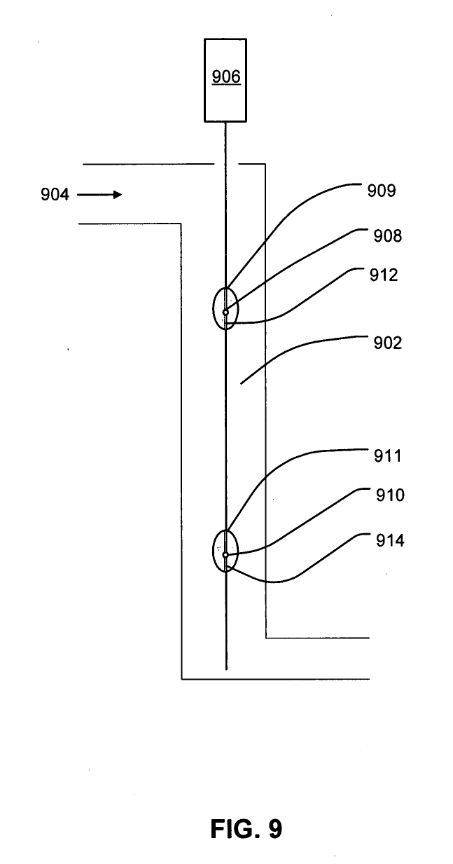

FIG. 9 illustrates a further embodiment of the present invention in which a single light source, a laser in this case, is used to illuminate multiple regions of interest in the same airflow. In this embodiment the detector 900 includes a single detection chamber 902 through which air flows in the direction of arrow 904. A laser light source 906 is provided to illuminate a volume within the airflow. This volume, is monitored at two places by photo-detectors 908 and 910 configured to receive light over a respective regions 909 and 911, thus defining two regions of interest 912 and 914. These regions of interest are spatially separated and the received light scattering signals, corresponding to the two regions of interest, can be used in the manner described above to validate a particle detection event or issue a fault condition.

As will be appreciated, embodiments of the present invention can be extended to any number of light sources, chambers, photo-detectors and regions of interest by making appropriate changes that will be apparent to those skilled in the art.

In some of the embodiments described herein the light sources described have been laser light sources. However the light sources could equally be one or more LEDs or other light sources. If an LED or other source of non-collimated light is used it may be necessary to use one or more optical devices (e.g. a lens) to focus or collimate the beam of light emitted by the light source.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

1. A method of detecting particles in an airflow, the method including:
illuminating a first volume through which at least part of the airflow passes detecting light scattered from the first volume;
illuminating a second volume through which at least part of the airflow passes;
comparing a value indicative of the light scattered from the first volume to a value indicative of the light scattered form the second volume; and
determining whether particles have been deleted in the airflow at last partially on the basis of the comparison.

2. A method as claimed in claim 1 wherein, in the event that the value indicative of the light scattered from the first value corresponds to a first detected particle level substantially similar to a second detected particle level corresponding to the measure ratio indicative of light scattered from the second volume; the method includes determining that particles have been detected.

3. A method as claimed in claim 1 wherein, in the event that the value, indicative of the light scattered from the first value corresponds to a first detected particle level not substantially similar to a second detected particle level corresponding to the measure ratio indicative of light scattered from the second volume; determining that a fault condition exists.

4. A method as claimed in claim 3 where the fault indicates contamination of a device in which either or both of the first or second volume reside.

5. A method as claimed in claim 3 wherein the method includes; provides a notification of the fault condition.

6. A method of identifying a false particle detection condition in a particle detector configured to detect particles in an airflow the particle detector including, means for illuminating a plurality of volumes traversed by at least part of the airflow, means for detecting light scattered from the plurality of volumes, said method including; comparing measurements indicative light scattered from the first volume and the second volume; and in the event that the light scattered from the first volume and the second volume do not correspond to substantially the same level of particles in the air flow; identifying that a false particle detection condition has occurred.

7. A method as claimed in claim 6 which further includes, in the event that the level of light scattered form the first and second volume correspond to substantially the same level of particles in the airflow indicating at least that particles have been detected.

8. A method in a particle detector of the type in which an air flow to be analysed passes through a detection chamber, for validating an initial particle detection event in respect of a first volume through which the airflow passes, the method including: attempting to detect particles in a second volume in the airflow that is different to the first volume in which the initial particle detection event occurred; and if a particle detection event occurs in the second volume; validating the initial particle detection event.

9. A method as claimed in claim 8 wherein the method can include causing an alarm if an initial particle detection even detected from the first even is validated.

10. A method as claimed in claim 1 wherein the particles to be detected are smoke particles.

11. An apparatus for detecting particles in an airflow the apparatus comprising:
at least one light source for illuminating at least one volume through which at least part of the airflow passes;
at least one photo-detector positioned to detect light scattered from a respective illuminated volume, so as to define a plurality of regions of interest at the intersection of a field of view of the photo detector and the illuminated volume;
a signal processing apparatus configured to process an output of at least two of said photo-detectors and to determine whether particles have been detected in the airflow.

12. An apparatus as claimed in claim 11 wherein the signal processing apparatus is further configured to determine a level of particles detected in the airflow and in the event that a predetermined condition is met to cause an alarm to be triggered, the processor means additionally being configured to compare a value indicative of an output of at least two of the plurality of photo-detectors and to determined an output of one of the photo-detectors is affected by a contaminant in its respective illuminated volume.

13. An apparatus as claimed in claim 11, wherein the signal processing apparatus includes means to compare a value representative of the outputs of two or more photo-detectors; determine whether a particle detection fault has occurred based upon the output of the comparison.

14. An apparatus as claimed in claim 11 wherein the apparatus includes a plurality of light sources.

15. An apparatus as claimed in claim 11, wherein the apparatus includes a plurality of photo-detectors.

16. An apparatus as claimed in claim 12 wherein in the event that the values indicative of an output of at least two of the plurality of photo-detectors are not substantially equal it is determined that a contaminant is present in one of the illuminated volumes of the apparatus.

17. An apparatus for detecting particles comprising;
a plurality of light sources illuminating a plurality of volumes within an airflow,
at least one photo-detector able to detect light scattered by particles within at least two of said volumes;
and wherein said light sources may be individually controlled in intensity in time to permit determination of which of said at volumes is the source of scattered light received at a photo-detector.

18. An apparatus for detecting particles as claimed in claim 17, wherein the light sources may be individually controlled in intensity according to a predetermined scheme.

19. An apparatus for detecting particles as claimed in claim 18, wherein the intensity modulation of the light sources is correlated with detected light scatter to determine which volume is the source of scattered light received at a photo-detector.

20. An apparatus for detecting particles as claimed in claim 17, further comprising signal processing means configured to recover a signals indicative of detected light scattered from each volume.

21. An apparatus for detecting particles of the type that detects light scattering from an illuminated volume to determine a level of particles in an airflow passing through said illuminated volume; said particle detection apparatus including a plurality of spatially separated, monitored, illuminated volumes from which scattered light is to be detected by one or more light detection stages; wherein said particle detection apparatus is configured to compare a signal indicative of the light scattered from a plurality of monitored, illuminated volumes to confirm the detection of particles in the airflow.

22. An apparatus for detecting particles as claimed in claim 21, wherein the apparatus confirms the detection of particles in the airflow if the output of a plurality of light detection stages that monitor a common airflow is substantially the same.

23. An apparatus for detecting particles as claimed in claim 21, further comprising a plurality of light sources configured to illuminate respective volumes of a common airflow.

24. An apparatus for detecting particles as claimed in claim 21, wherein the light sources are activated and deactivated to illuminate their respective volumes of the airflow in a predetermined pattern.

25. An apparatus for detecting particles as claimed in claim 21, wherein the light sources are activated and deactivated to illuminate their respective volumes of the airflow in a manner responsive to a level of particles detected.

26. An apparatus for detecting particles as claimed in claim 21, wherein illumination of one or more of the illuminated volumes is at least temporarily stopped in the event that one of more of the following conditions is met:
a predetermined concentration of particles is detected;
the rate or change of the concentration of particles detected meets a predetermined condition.

27. A method, in a particle detector in which an air flow to be analysed passes through a detection chamber, for validating an initial particle detection event in respect of a first volume through which the airflow passes, the method comprising:
attempting to detect particles in a second volume in the airflow that is different to the first volume in which the initial particle detection event occurred; and
in the event that a particle detection event occurs in the second volume;
validating the initial particle detection event.

28. The method as claimed in claim 27, wherein the method includes attempting to detect particles in a first volume, and if particles are detected, determining that an initial particle detection event has occurred.

29. The method as claimed in claim 27, further comprising causing alarm if the initial particle detection event is validated and one or more additional alarm conditions is met.

30. An apparatus for detecting particles in an airflow the apparatus including:
at least one light source for illuminating a one or more portions of the airflow;
at least one photo-detector positioned to detect light scattered from one or more illuminated volumes of the airflow; wherein said at least one light source and at least one photo detector are arranged such that a signal indicative of light scattered from a plurality of illuminated volumes can be derived from the output of the at least one photo detector; and
a signal processing apparatus configured to process said signals indicative of light scattered from a plurality of illuminated volumes to determine whether particles have been detected in the airflow.

31. An apparatus for detecting particles according to claim 30, wherein the particles to be detected are smoke particles.

32. A particle detection system including an apparatus for detecting particles as claimed in claim 11.

33. A particle detection system as claimed in claim 32 further including a sampling network for introducing an air flow to the particle detection system.
